(19) United States
(12) Patent Application Publication
(10) Pub. No.: US 2009/0036641 A1
(43) Pub. Date: Feb. 5, 2009

(54) Anionic Soil Release Polymers

(76) Inventors: Frank-Peter Lang, Hattersheim (DE); Steve Laborda, Dietzenbach (DE); Georg Borchers, Bad Nauheim (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/086,925

(22) PCT Filed: Dec. 7, 2006
(86) PCT No.: PCT/EP2006/011756

§ 371 Date: Jul. 15, 2008

(30) Foreign Application Priority Data
Dec. 21, 2005 (DE) 10 2005 061 058.7

(51) Int. Cl. C08G 63/688

(52) U.S. Cl. 528/295

(57) ABSTRACT

Anionic soil release polyesters are described which consist of terephthalic acid, sulfoisophthalic acid-(poly)alkylene glycol, a non-ionic end group and optionally a polyfunctional crosslinking monomer. These polyesters are suitable as soil release components in washing and cleaning compositions.

The invention relates to the preparation of polyesters from the monomers terephthalic acid, 5-sulfoisophthalic acid, alkyldiols or polyalkylene glycols, and polyalkylene glycol monoalkyl ethers and their use in detergents and cleaners.

Polyesters of aromatic dicarboxylic acids, such as terephthalic acid, isophthalic acid, sulfonated aromatic dicarboxylic acids, such as sulfoisophthalic acid, and diols, such as alkylene glycol and their use have been known for a long time as “soil release polymers (SRP)” and are described in numerous patents.

U.S. Pat. No. 4,427,557 describes polyesters with molecular weights in the region of 2000 and 10 000 g/mol, prepared from the monomers ethylene glycol (1), polyethylene glycol (2) with molecular weights of from 200 to 1000 g/mol, aromatic dicarboxylic acids (3) and alkali metal salts of sulfonated aromatic dicarboxylic acids (4), and proclaims their soil release effect on polyester fabric.

U.S. Pat. No. 4,702,857 claims polyesters of ethylene glycol, 1,2-propylene glycol or mixtures thereof (1), polyethylene glycol with at least 10 glycol units which is capped at one end with a short-chain alkyl group, in particular with a methyl group (2), a dicarboxylic acid or dicarboxylic acid ester (3) and optionally alkali metal salts of sulfonated aromatic dicarboxylic acids (4).

U.S. Pat. No. 4,721,580 discloses polyesters with terephthalate units and sulfo-containing end groups, in particular sulfoethoxylated end groups MO₃S(CH₂CH₂O)ₙ—H and proclaims their use in detergents and fabric softeners.

U.S. Pat. No. 4,968,451 describes polyesters with sulfo-containing end groups obtained by copolymerization of (meth)allyl alcohol, alkylene oxide, aryl dicarboxylic acid and C₂-C₄-glycol and subsequent sulfonation.

U.S. Pat. No. 5,415,807 explains that soil release polymers with sulfonated polyethoxy/propoxy end groups have a tendency toward crystallization, resulting in a reduction in the soil release effects. The publication teaches that the crystallization tendency of the SRP can be suppressed by adding hydrotropes.

U.S. Pat. No. 5,691,298 claims soil release polymers with branched backbone of di- or polyhydroxysulfonate, terephthalate and 1,2-oxyalkylenoxy units with nonionic or anionic end groups.

Anionic soil release polymers with sulfo-containing groups known hitherto are characterized by good solubility in water, but have a tendency toward hygroscopicity and stickiness. Direct grinding of the chilled polyester melts by hammer mill, screen mill or so-called roller mill is not possible. The high absorption of water during the grinding process leads to agglutinations and thus to the continuous operation being interrupted. Even if acceptable results can be achieved through special, energy-intensive processes such as low-temperature grinding (cryogrinding) or spray-drying processes from aqueous solution, the storage stability of the anionic SRP granules remains limited on account of the water absorption capacity.

The object of the present invention was to prepare anionic polyesters which are readily soluble in water, exhibit good soil release effect, are compatible with additives and auxiliaries customary in detergents and cleaners, can be incorporated easily into formulations and are hydrolysis-stable. Additionally, it should be possible to formulate them in the form of storage-stable granules without high energy expenditure.

Surprisingly, it has been found that this object is achieved by anionic polyesters which are formally derived from terephthalic acid, 5-sulfoisophthalic acid or the salt of 5-sulfoisophthalic acid, from ethylene glycol or polyethylene glycol, propylene glycol or polypropylene glycol and polyalkylene glycol monoalkyl ether, and optionally from further monomers having 3 to 6 functions capable of polycondensation, in particular acid, alcohol or ester functions.

These anionic polyesters exhibit improved soil release effect, have very good dissolution behavior and are considerably less sensitive to moisture. It is particularly advantageous that they can easily be converted into granules by grinding and can be supplied in the desired particle size distribution.

The invention provides polyesters comprising structural units 1 to 3 or 1 to 4:

| | | |
|---|---|---|
| 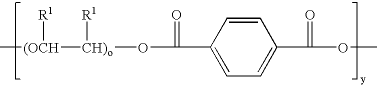 | (1) | PETunit |
| 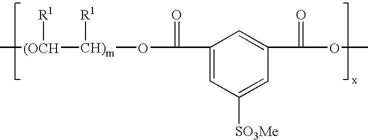 | (2) | SIPunit |
| 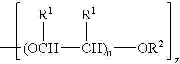 | (3) | endstops |
| 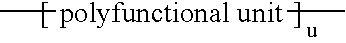 | (4) | cross-linker |

where
R¹, independently of the others, is H or a (C₁-C₁₈) n- or isoalkyl group, preferably methyl,
R² is a linear or branched (C₁-C₃₀)-alkyl group or a linear or branched (C₂-C₃₀)-alkenyl group, a cycloalkyl group having 5 to 9 carbon atoms, a (C₆-C₃₀) aryl group or a (C₆-C₅₀) arylalkyl group, preferably phenyl or benzyl,
m, n, o, independently of one another, are a number from 1 to 200,
x, y and z, independently of one another, are numbers from 1 to 50,
with the proviso that x+y must be ≧2 and z must be >0,
u is a number from 0 to 5, preferably 0 to 0.5 and particularly preferably from 0 to 0.25 and
Me is Li⁺, Na⁺, K⁺, Mg⁺⁺/2, Ca⁺⁺/2, Al⁺⁺⁺/3, NH₄⁺, a monoalkylammonium ion, dialkylammonium ion, trialkylammonium ion and/or tetraalkylammonium ion, where the alkyl substituents of the ammonium ions are, independently of one another, (C₁-C₂₂)-alkyl radicals or (C₂-C₁₀)-hydroxyalkyl radicals.

The invention preferably provides polyesters, as defined above, where R¹ is H and/or methyl, R² is methyl, o, m and n are a number from 1 to 200, preferably 1 to 20, particularly preferably 1 to 5, extraordinarily preferably o and m=1 and n can be a number from 2 to 10,

x is a number between 1 and 30, preferably between 2 and 15, particularly preferably between 3 and 10,
y is a number between 1 and 25, preferably between 1 and 10, particularly preferably between 1 and 5, and z is a number between 0.05 and 15, preferably between 0.1 and 10, particularly preferably between 0.25 and 3.

The polyesters according to the invention are obtained by polycondensation of terephthalic acid dialkyl esters, 5-sulfoisophthalic acid dialkyl esters, alkylene glycols, optionally polyalkylene glycols (when m and/or o>1) and polyalkylene glycols terminally capped at one end (end stops).

It should be pointed out that for numbers m, n, o>1, a polymeric structure is present and thus the coefficients can assume any desired value in the given interval. This value reflects the number-average molecular weight.

For the purposes of the invention, PET unit (1) is understood as meaning the ester of terephthalic acid with one or more difunctional, aliphatic alcohols. Preference is given here to using ethylene glycol (R¹ in each case H) or 1,2-propylene glycol (R¹═H and —CH₃) and/or shorter-chain polyethylene glycols and/or poly[ethylene glycol-co-propylene glycol] with number-average molecular weights of from 100 to 2000 g/mol. Particular preference is given to mixtures of ethylene oxide and propylene oxide. 1 to 50 PET units may be present per polymer chain in the structures according to the invention. It is clear to the expert that these are always statistical average values with a natural distribution that varies from system to system.

For the purposes of the invention, SIP unit (2) is understood as meaning the ester of 5-sulfoisophthalic acid with one or more difunctional, aliphatic alcohols. Preference is given here to using ethylene glycol (R¹ in each case H) and/or 1,2-propylene glycol (R¹═H and —CH₃) or shorter-chain polyethylene glycols with number-average molecular weights of from 100 to 2000 g/mol. Particular preference is given to mixtures of ethylene oxide and propylene oxide. 1 to 50 SIP units may be present in the structures according to the invention. The statements made above regarding statistical distributions also apply here.

For the purposes of the invention, end stops (3) are all polyalkylene glycol monoalkyl ethers nonionically capped at one end as in structural unit (3). Preference is given to using poly[ethylene glycol-co-propylene glycol] monomethyl ether with average molecular weights of from 100 to 2000 g/mol and polyethylene glycol monomethyl ethers of the general form: CH₃—O—(C₂H₄O)ₙ—H where n≧1 to 99, where n=1 to 20 is preferably used. Very particular preference is given to polyesters with polyalkylene glycol monoalkyl ethers of the general form: CH₃—O—(C₂H₄O)ₙ—H where n=2 to 10 as end group.

Since by using end stops the theoretical maximum average molecular weight of a polyester structure to be achieved upon quantitative conversion is pregiven, the use amount according to the invention of structural unit (3) is that which is required to achieve the average molecular weights according to the invention described above.

Besides linear polyesters which result from the structural units 1-3 described above, crosslinked or branched polyester structures are also possible for the purposes of the invention. This is expressed by the presence of a crosslinking polyfunctional structural unit (4) with at least three to at most 6 functional groups capable of the esterification reaction. Functional groups which may be mentioned here are, for example, acid, alcohol, ester, anhydride or epoxy groups. Here, different functionalities in one molecule are also within the meaning of the invention.

Preferred examples that may be mentioned here are citric acid, malic acid, tartaric acid and gallic acid, particularly preferably 2,2-dihydroxymethylpropionic acid.

Furthermore, preference is given to using polyhydric alcohols, such as pentaerythritol, glycerol, sorbitol and trimethylolpropane.

Furthermore, preference is given to polybasic aliphatic and aromatic carboxylic acids, such as benzene-1,2,3-tricarboxylic acid (hemimellitic acid), benzene-1,2,4-tricarboxylic acid (trimellitic acid), particularly preferably benzene-1,3,5-tricarboxylic acid (trimesitic acid).

The weight fraction of crosslinking monomers, based on the total mass of the polyesters, is preferably 0 to 10% by weight, particularly preferably 0 to 5% by weight and especially preferably 0 to 3% by weight.

The polyesters according to the invention comprising the structural units 1, 2 and 3 and optionally crosslinking monomers 4 generally have number-average molecular weights in the range from 700 to 50 000 g/mol, the number-average molecular weight being determined by means of size exclusion chromatography in aqueous solution using a calibration with the help of narrow-distribution polyacrylic acid Na salt standard. At this point it should be noted that all of the molecular weight data in this publication refers to the number-average molecular weight even if this is not explicitly mentioned.

Preferably, the number-average molecular weights are in the range from 800 to 25 000 g/mol, in particular 1000 to 15 000 g/mol, particularly preferably 1200 to 12 000 g/mol.

The molar use amounts of structural unit 3 are chosen so that the number-average molecular weights specified in the invention are achieved. A preferred subject matter of the invention is solid polyesters, as defined above, which have softening points above 40° C. The solid polyesters according to the invention preferably have a softening point between 50 and 200° C., particularly preferably between 80° C. and 150° C. and extraordinarily preferably between 100° C. and 120° C.

The advantage of these polyesters is that they remain pourable upon storage at 0° C. to 40° C. for several months and exhibit no stickiness of any kind.

The synthesis of the polyesters according to the invention takes place by processes known per se by heating the abovementioned components with the addition of a catalyst initially at atmospheric pressure to temperatures of from 160 to about 220° C. using an inert atmosphere. The required molecular weights are then built up in vacuo at temperatures of from 160 to about 240° C. by distilling of super stoichiometric amounts of the glycols used. The known transesterification and condensation catalysts of the prior art, such as, for example, titanium tetraisopropoxide, dibutyl tin oxide, alkali metal or alkaline earth metal alkoxides or antimony trioxide/calcium acetate, are suitable for the reaction. For further details for carrying out the process, reference is made to EP 442 101.

A preferred process for the preparation of the polyesters according to the invention is one in which the condensation of the components is carried out in a single-pot process, where the transesterification and condensation catalysts are added prior to heating.

The polyesters according to the invention are of solid consistency and can be ground in a simple manner to give powders, or compacted and/or agglomerated to give granules of defined particle sizes.

The granulation of the polyesters according to the invention can take place by solidifying the copolymers produced during the synthesis as melt by cooling in a cool gas stream, for example stream of air or nitrogen, or advantageously by application to a flaking roll or to a conveyor belt at 40 to 80° C., preferably 45 to 55° C., to give flakes. This coarse material can be ground, for example, in a roller mill or in a screen mill, which can follow a screening. The granulation can also take place by grinding the polyesters according to the invention after solidification to give powders with particle sizes <400 μm and then converting them to granules with defined particle sizes through compaction and/or agglomeration.

For specific embodiments, it may also be advantageous to dissolve the melt or the solidified flakes in water and to granulate aqueous solutions with concentrations of from 1 to 99% by weight of polyester in a spray tower at inlet temperatures of from 150 to 180° C. and exit temperatures of from 80 to 120° C. under atmospheric pressure in the fluidized bed.

The particle size of the granules prepared in this way is generally in the range from 100 μm-2000 μm, preferably 300 μm-1800 μm, particularly preferably 600 μm-1200 μm. The bulk density is in the range from 400 to 700 kg/m³.

Moreover, the invention provides the use of the polyesters according to the invention in detergents and cleaners, textile care compositions and compositions for the finishing of textiles. The polyesters according to the invention impart to the textile fibers significantly improved soil release properties and assist the soil release power of the other detergent constituents toward oily, greasy or pigment soilings to a considerable degree. The use of the polyesters according to the invention can further be of advantage in aftertreatment compositions for laundry, for example in a fabric softener.

With the help of the polyesters according to the invention in cleaners for hard surfaces, the treated surfaces can be provided with a soil repellent finish.

The detergent and cleaner formulations in which the polyesters according to the invention can be used are pulverulent, granular, pasty, gel-like or liquid.

Examples thereof are heavy-duty detergents, mild-action detergents, color detergents, wool detergents, net curtain detergents, modular detergents, washing tablets, bar soaps, stain salts, laundry starches and stiffeners, ironing aids. The polyesters according to the invention can also be incorporated into household cleaners, for example all-purpose cleaners, dishwashing detergents, carpet cleaners and impregnation products, cleaners and care compositions for floors and other hard surfaces, e.g. made of plastic, ceramic, glass or surfaces coated using nanotechnology.

Examples of technical cleaners are plastics cleaners and care compositions, for example for housings and dashboards, and cleaners and care compositions for painted surfaces such as, for example, automotive bodywork.

The washing, care and cleaning composition formulations according to the invention comprise at least 0.1% by weight, preferably between 0.1 and 10% by weight and particularly preferably 0.2 to 3% by weight of the polyesters according to the invention, based on the finished compositions. Depending on their intended use, the formulations can be adapted in their composition to the nature of the textiles to be treated or washed or to the surfaces to be cleaned.

The detergents and cleaners according to the invention can comprise customary ingredients, such as surfactants, emulsifiers, builders, bleaching catalysts and bleach activators, sequestrants, graying inhibitors, color transfer inhibitors, color fixatives, enzymes, optical brighteners, softening component. Furthermore, formulations or parts of the formulation within the meaning of the invention can be colored and/or perfumed by dyes and/or fragrances in a targeted manner.

The total concentration of surfactants in the finished detergent and cleaner formulation can be from 1 to 99% and preferably from 5 to 80% (all % by weight). The surfactants used may be anionic, nonionic, amphoteric or cationic. Mixtures of said surfactants can also be used. Preferred detergent and cleaner formulations comprise anionic and/or nonionic surfactants and mixtures thereof with further surfactants.

Suitable anionic surfactants are sulfates, sulfonates, carboxylates, phosphates and mixtures thereof. Suitable cations here are alkali metals, such as, for example, sodium or potassium, or alkaline earth metals, such as, for example, calcium or magnesium, and also ammonium, substituted ammonium compounds, including mono-, di- or triethanolammoniumcations, and mixtures thereof. The following types of anionic surfactants are of particular interest:

alkyl ester sulfonates, alkyl sulfates, alkyl ether sulfates, alkylbenzenesulfonates, alkanesulfonates and soaps, as described below.

Alkyl ester sulfonates are, inter alia, linear esters of C₈-C₂₀-carboxylic acids (i.e. fatty acids) which are sulfonated by means of gaseous SO₃, as is described in “The Journal of The American Oil Chemists Society” 52 (1975), pp. 323-329. Suitable starting materials are natural fats such as, for example, tallow, coconut oil and palm oil, but may also be synthetic in nature. Preferred alkyl ester sulfonates, specifically for detergent applications, are compounds of the formula

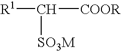

in which R¹ is a C₈-C₂₀-hydrocarbon radical, preferably alkyl, and R is a C₁-C₆ hydrocarbon radical, preferably alkyl. M is a cation which forms a water-soluble salt with the alkyl ester sulfonate. Suitable cations are sodium, potassium, lithium or ammonium cations, such as monoethanolamine, diethanolamine and triethanolamine. Preferably, R¹ is C₁₀-C₁₆-alkyl and R is methyl, ethyl or isopropyl. Particular preference is given to methyl ester sulfonates in which R¹ is C₁₀-C₁₆-alkyl.

Alkyl sulfates are here water-soluble salts or acids of the formula ROSO₃M, in which R is a C₁₀-C₂₄-hydrocarbon radical, preferably an alkyl or hydroxyalkyl radical with C₁₀-C₂₀-alkyl component, particularly preferably a C₁₂-C₁₈-alkyl or hydroxyalkyl radical. M is hydrogen or a cation, e.g. an alkali metal cation (e.g. sodium, potassium, lithium) or ammonium or substituted ammonium, e.g. methyl-, dimethyl- and trimethylammonium cations and quaternary ammonium cations, such as tetramethylammonium and dimethylpiperidinium cations and quaternary ammonium cations, derived from alkylamines such as ethylamine, diethylamine, triethylamine and mixtures thereof. Alkyl chains with C₁₂-C₁₆ are preferred for low washing temperatures (e.g. below about 50° C.) and alkyl chains with C₁₆-C₁₈ are preferred for higher washing temperatures (e.g. above about 50° C.).

Alkyl ether sulfates are water-soluble salts or acids of the formula RO(A)ₘSO₃M, in which R is an unsubstituted C₁₀-C₂₄-alkyl or hydroxyalkyl radical, preferably a C₁₂-C₂₀ alkyl or hydroxy alkyl radical, particularly preferably C₁₂-C₁₈-alkyl or hydroxyl alkyl radical. A is an ethoxy or propoxy unit, m is a number greater than 0, preferably between about 0.5 and about 6, particularly preferably between about 0.5 and about 3 and M is a hydrogen atom or a cation, such as, for example, sodium, potassium, lithium, calcium, magnesium, ammonium or a substituted ammonium cation. Specific examples of substituted ammonium cations are methyl, dimethyl, trimethyl ammonium and quaternary ammonium cations, such as tetramethylammonium and dimethylpiperidinium cations, and also those which are derived from alkylamines, such as ethylamine, diethylamine, triethylamine, or mixtures thereof. Examples which may be mentioned are C₁₂- to C₁₈-fatty alcohol ether sulfates, where the content of EO is 1, 2, 2.5, 3 or 4 mol per mol of the fatty alcohol ether sulfate, and in which M is sodium or potassium.

In secondary alkanesulfonates, the alkyl group can either be saturated or unsaturated, branched or linear and optionally substituted by a hydroxyl group. The sulfo group can be at any desired position on the carbon chain, the primary methyl groups at the chain start and chain end having no sulfonate groups. The preferred secondary alkanesulfonates comprise linear alkyl chains having about 9 to 25 carbon atoms, preferably about 10 to about 20 carbon atoms and particularly preferably about 13 to 17 carbons atoms. The cation is, for example, sodium, potassium, ammonium, mono-, di- or triethanolammonium, calcium or magnesium, and mixtures thereof. Sodium as cation is preferred.

Besides secondary alkanesulfonates, it is also possible to use primary alkanesulfonates in the detergents and cleaners according to the invention. The preferred alkyl chains and cations correspond to those of the secondary alkanesulfonates.

The preparation of primary alkanesulfonic acid from which the corresponding sulfonates effective as surfactant are obtained is described, for example, in EP 854 136 A1.

Further suitable anionic surfactants are alkenyl- or alkylbenzenesulfonates. The alkenyl or alkyl groups can be branched or linear and optionally substituted by a hydroxyl group. The preferred alkylbenzenesulfonates comprise linear alkyl chains having about 9 to 25 carbon atoms, preferably from about 10 to about 13 carbon atoms, the cation is sodium, potassium, ammonium, mono-, di- or triethanolammonium, calcium or magnesium and mixtures thereof. For mild surfactant systems, magnesium is preferred as cation, whereas for standard washing applications, sodium is preferred. The same is true for alkenylbenzenesulfonates.

The term anionic surfactants also includes olefinsulfonates which are obtained by sulfonation of C₁₂-C₂₄-, preferably C₁₄-C₁₆-α-olefins with sulfur trioxide and subsequent neutralization. As a result of the preparation process, these olefinsulfonates can comprise relatively small amounts of hydroxyalkanesulfonates and alkanedisulfonates. Specific mixtures of α-olefin sulfonates are described in U.S. Pat. No. 3,332,880.

Further preferred anionic surfactants are carboxylates, e.g. fatty acid soaps and comparable surfactants. The soaps may be saturated or unsaturated and can comprise various substituents, such as hydroxyl groups or α-sulfonate groups. Linear saturated or unsaturated hydrocarbon radicals as hydrophobic moiety with about 6 to about 30, preferably about 10 to about 18, carbon atoms are preferred.

Suitable anionic surfactants are also salts of acylaminocarboxylic acids, the acyl sarcosinates which form by reacting fatty acid chlorides with sodium sarcosinate in an alkaline medium; fatty acid-protein condensation products which are obtained by reacting fatty acid chlorides with oligopeptides; salts of alkylsulfamidocarboxylic acids; salts of alkyl- and alkylaryl ether carboxylic acids; C₈-C₂₄-olefinsulfonates, sulfonated polycarboxylic acids, prepared by sulfonation of the pyrolysis products of alkaline earth metal citrates, as described, for example in GB-1,082,179; alkylglycerol sulfates, oleylglycerol sulfates, alkylphenol ether sulfates, primary paraffinsulfonates, alkyl phosphates, alkyl ether phosphates, isethionates, such as acyl isethionates, N-acyltaurides, alkyl succinates, sulfosuccinates, monoesters of the sulfosuccinates (particularly saturated and unsaturated C₁₂-C₁₈-monoesters) and diesters of sulfosuccinates (particularly saturated and unsaturated C₁₂-C₁₈-diesters), acyl sarcosinates, sulfates of alkyl polysaccharides, such as sulfates of alkyl polyglycosides, branched primary alkyl sulfates and alkyl polyethoxycarboxylates, such as those with the formula RO(CH₂CH₂)ₖCH₂COO⁻M⁺, in which R is C₈ to C₂₂-alkyl, k is a number from 0 to 10 and M is a cation, resin acids or hydrated resin acids, such as rosin or hydrated rosin or tall oil resins and tall oil resin acids.

Suitable nonionic surfactants are, for example, the following compounds, polyethylene, polypropylene and polybutylene oxide condensates of alkylphenols.

These compounds include the condensation products of alkylphenols with a C₆- to C₂₀-alkyl group, which may either be linear or branched, with alkene oxides. Preference is given to compounds with about 5 to 25 mol of alkene oxide per mol of alkylphenol. Commercially available surfactants of this type are, for example, Igepal® CO-630, Triton® X-45, X-114, X-100 and X102, and the ®Arkopal-N brands of Clariant GmbH. These surfactants are referred to as alkylphenol alkoxylates, e.g. alkylphenol ethoxylates.

Condensation products of aliphatic alcohols with about 1 to about 25 mol of ethylene oxide.

The alkyl chain of the aliphatic alcohols can be linear or branched, primary or secondary, and generally comprises about 8 to about 22 carbon atoms. Particular preference is given to the condensation products of C₁₀- to C₂₀-alcohols with about 2 to about 18 mol of ethylene oxide per mol of alcohol. The alkyl chain can be saturated or unsaturated. The alcohol ethoxylates can have a narrow homolog distribution of the ethylene oxide (“narrow range ethoxylates”) or a broad homolog distribution of the ethylene oxide (“broad range ethoxylates”). Examples of commercially available nonionic surfactants of this type are Tergitol® 15-S-9 (condensation product of a linear secondary C₁₁-C₁₅-alcohol with 9 mol of ethylene oxide), Tergitol® 24-L-NMW (condensation product of a linear primary C₁₂-C₁₄-alcohol with 6 mol of ethylene oxide in the case of narrow molecular weight distribution). The Genapol® brands of Clariant GmbH likewise fall under this product class.

Condensation products of ethylene oxide with a hydrophobic basis, formed by condensation of propylene oxide with propylene glycol.

The hydrophobic moiety of these compounds preferably has a molecular weight between about 1500 and about 1800. The addition of ethylene oxide onto this hydrophobic moiety leads to an improvement in the water solubility. The product is liquid up to a polyoxyethylene content of about 50% of the total weight of the condensation product, which corresponds to a condensation with up to about 40 mol of ethylene oxide. Commercially available examples of this product class are the Pluronic® brands of BASF and the ®Genapol PF brands of Clariant GmbH.

Condensation products of ethylene oxide with a reaction product of propylene oxide and ethylene diamine.

The hydrophobic unit of these compounds consists of the reaction product of ethylene diamine with excess propylene oxide and generally has a molecular weight of from about 2500 to 3000. Ethylene oxide is added onto this hydrophobic unit up to a content of about 40 to about 80% by weight of polyoxyethylene and a molecular weight of about 5000 to 11 000. Commercially available examples of this compound class are the ®Tetronic brands of BASF and the ®Genapol PN brands of Clariant GmbH.

### Semipolar Nonionic Surfactants

This category of nonionic compounds includes water-soluble amine oxides, water-soluble phosphine oxides and water-soluble sulfoxides, each having an alkyl radical of from about 10 to about 18 carbon atoms. Semipolar nonionic surfactants are also amine oxides of the formula

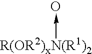

where R is an alkyl, hydroxyalkyl or alkylphenol group with a chain length of from about 8 to about 22 carbon atoms, R² is an alkylene or hydroxy alkylene group having about 2 to 3 carbon atoms or mixtures thereof, each radical R¹ is an alkyl or hydroxyalkyl group having about 1 to about 3 carbon atoms or a polyethylene oxide group having about 1 to about 3 ethylene oxide units, and x is a number from 0 to about 10. The R¹ groups may be joined together via an oxygen or nitrogen atom and thus form a ring. Amine oxides of this type are particularly C₁₀-C₁₈-alkyldimethylamine oxides and C₈-C₁₂-alkoxyethyldihydroxyethylamine oxides.

### Fatty Acid Amides

Fatty acid amides have the formula

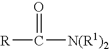

in which R is an alkyl group having about 7 to about 21, preferably about 9 to about 17, carbon atoms, and each radical R¹ is hydrogen, C₁-C₄-alkyl, C₁-C₄-hydroxyalkyl or (C₂H₄O)ₓH, where x varies from about 1 to about 3. Preference is given to C₈-C₂₀-amides, -monoethanolamides, -diethanolamides and -isopropanolamides.

Further suitable nonionic surfactants are alkyl and alkenyl oligoglycosides, and also fatty acid polyglycol esters or fatty amine polyglycol esters having in each case 8 to 20, preferably 12 to 18, carbon atoms in the fatty alkyl radical, alkoxylated triglycamides, mixed ethers or mixed formyls, alkyl oligoglycosides, alkenyl oligoglycosides, fatty acid N-alkylglucamides, phosphine oxides, dialkyl sulfoxides and protein hydrolysates.

Typical examples of amphoteric and zwitterionic surfactants are alkylbetaines, alkylamidebetaines, aminopropionates, aminoglycinates, or amphoteric imidazolinium compounds of the formula

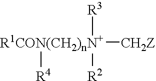

in which R¹ is C₈-C₂₂-alkyl or -alkenyl, R² is hydrogen or CH₂CO₂M, R³ is CH₂CH₂OH or CH₂CH₂OCH₂CH₂CO₂M, R⁴ is hydrogen, CH₂CH₂OH or CH₂CH₂COOM, Z is CO₂M or CH₂CO₂M, n is 2 or 3, preferably 2, M is hydrogen or a cation, such as alkali metal, alkaline earth metal, ammonium or alkanolammonium.

Preferred amphoteric surfactants of this formula are monocarboxylates and dicarboxylates. Examples thereof are cocoamphocarboxypropionate, cocoamidocarboxypropionic acid, cocoamphocarboxyglycinate (or also referred to as cocoamphodiacetate) and cocoamphoacetate.

Further preferred amphoteric surfactants are alkyldimethylbetaines and alkyldipolyethoxybetaines with an alkyl radical having about 8 to about 22 carbon atoms, which may be linear or branched, preferably having 8 to 18 carbon atoms and particularly preferably having about 12 to about 18 carbon atoms. These compounds are marketed, for example, by Clariant GmbH under the trade name ®Genagen LAB.

Suitable cationic surfactants are substituted or unsubstituted straight-chain or branched quaternary ammonium salts of the type R¹N(CH₃)₃^{ρ}X^{σ}, R¹R²N(CH₃)₂^{ρ}X^{σ}, R¹R²R³N(CH₃)^{ρ}X^{σ} or R¹R²R³R⁴N^{ρ}X^{σ}. The radicals R¹, R², R³ and R⁴ can preferably be, independently of one another, unsubstituted alkyl with a chain length between 8 and 24 carbon atoms, in particular between 10 and 18 carbon atoms, hydroxyalkyl having about 1 to about 4 carbon atoms, phenyl, C₂- to C₁₈-alkenyl, C₇- to C₂₄-aralkyl (C₂H₄O)ₓH, where x is from about 1 to about 3, alkyl radicals containing one or more ester groups, or cyclic quaternary ammonium salts. X is a suitable anion.

In preferred embodiments, the detergents and cleaners according to the invention comprise linear alkylbenzenesulfonate. The preferred alkylbenzenesulfonates comprise linear alkyl chains having about 9 to 25 carbon atoms, preferably from about 10 to about 13 carbon atoms, the cation is sodium, potassium, ammonium, mono-, di- or triethanolammonium, calcium or magnesium and mixtures thereof. For mild surfactant systems, magnesium is preferred as cation, whereas for standard washing applications, sodium is preferred. In likewise preferred embodiments, the detergents and cleaners according to the invention comprise secondary alkanesulfonates with linear alkyl chains having about 9 to 25 carbon atoms, preferably about 10 to about 20 carbon atoms and particularly preferably about 13 to 17 carbon atoms. The cation is, for example, sodium, potassium, ammonium, mono-, di- or triethanolammonium, calcium or magnesium, and mixtures thereof. Sodium is preferred as cation.

In likewise preferred embodiments, the detergents and cleaners according to the invention comprise alkyl ether sulfates of the formula RO(A)ₘSO₃M, in which R is an unsubstituted C₁₀-C₂₄-alkyl or hydroxyalkyl radical, preferably a C₁₂-C₂₀-alkyl or hydroxyalkyl radical, particularly preferably C₁₂-C₁₈-alkyl or hydroxyalkyl radical. A is an ethoxy or propoxy unit, m is a number greater than 0, preferably between about 0.5 and about 6, particularly preferably between about 0.5 and about 3, and M is a hydrogen atom or a cation such as, for example, sodium, potassium, lithium, calcium, magnesium, ammonium or a substituted ammonium cation. Specific examples of substituted ammonium cations are methyl, dimethyl, trimethylammonium and quaternary ammonium cations such as tetramethylammonium and dimethylpiperidinium cations, and also those which are derived from alkylamines, such as ethylamine, diethylamine, triethylamine or mixtures thereof. Examples which may be mentioned are C₁₂- to C₁₈-fatty alcohol ether sulfates, where the content of EO is 1, 2, 2.5, 3 or 4 mol per mol of the fatty alcohol ether sulfate, and in which M is sodium or potassium.

Suitable emulsifiers are addition products of from 0 to 30 mol of alkylene oxide, in particular ethylene oxide, propylene oxide and/or butylene oxide, onto linear or branched, saturated or unsaturated fatty alcohols having 8 to 22 carbon atoms, onto fatty acids having 12 to 22 carbon atoms, onto alkylphenols having 8 to 15 carbon atoms in the alkyl group and onto sorbitan esters;

(C₁₂-C₁₈)-fatty acid mono- and diesters of addition products of from 0 to 30 mol of ethylene oxide onto glycerol;
glycerol mono- and diesters and sorbitan mono- and diesters of saturated and unsaturated fatty acids having 6 to 22 carbon atoms and optionally ethylene oxide addition products thereof;
addition products of from 5 to 60 mol, preferably 15 to 60 mol, of ethylene oxide onto castor oil and/or hydrogenated castor oil;
polyol, and in particular polyglycerol, esters, such as, for example, polyglycerol polyricinoleate and polyglycerol poly-12-hydroxystearate.

Preference is given to liquid fatty acid esters which may be either ethoxylated (PEG-10 polyglyceryl-2 laurate) and also nonethoxylated (polyglycerol-2 sesquiisostearate).

Further preferred mixtures according to the invention comprise sorbitol esters prepared by reacting sorbitol with fatty acid methyl esters or fatty acid triglycerides. The fatty acid radical in the fatty acid methyl esters and fatty acid triglycerides contains in general 8 to 22 carbon atoms and can be straight-chain or branched, saturated or unsaturated. Examples thereof are palmitic acid, stearic acid, lauric acid, linoleic acid, linolenic acid, isostearic acid or oleic acid. Suitable fatty acid triglycerides are all native animal or vegetable oils, fats and waxes, for example olive oil, rapeseed oil, palm kernel oil, sunflower oil, coconut oil, linseed oil, castor oil, soybean oil, optionally also in refined or hydrogenated form. Since these natural fats, oils and waxes are normally mixtures of fatty acids with varying chain length, this also applies for the fatty acid radicals in the sorbitol esters used according to the invention. The sorbitol esters used according to the invention can also be alkoxylated, preferably ethoxylated.

Furthermore, anionic emulsifiers, such as ethoxylated and nonethoxylated mono-, di- or triphosphoric acid esters, but also cationic emulsifiers, such as mono-, di- and trialkyl quats and polymeric derivatives thereof, can be used.

Mixtures of compounds from two or more of these substance classes are likewise suitable.

Further detergent and cleaner ingredients which may be present in the present invention include inorganic and/or organic builders in order to reduce the degree of hardness of the water.

These builders may be present in weight fractions of from about 5 to about 80% in the detergent and cleaner compositions. Inorganic builders include, for example, alkali metal, ammonium and alkanolammonium salts of polyphosphates, such as, for example, tripolyphosphates, pyrophosphates and glass-like polymeric metaphosphates, phosphonates, silicates, carbonates including bicarbonates and sesquicarbonates, sulfates and aluminosilicates.

Examples of silicate builders are the alkali metal silicates, in particular those with an SiO₂:Na₂O ratio between 1.6:1 and 3.2:1, and also sheet silicates, for example sodium sheet silicates, as described in U.S. Pat. No. 4,664,839, obtainable from Clariant GmbH under the brand SKS®. SKS-6® is a particularly preferred sheet silicate builder.

Aluminosilicate builders are particularly preferred for the present invention. These are, in particular, zeolites with the formula Na_{z}[(AlO₂)_{z}(SiO₂)_{y}].xH₂O, in which z and y are integers of at least 6, the ratio of z to y is between 1.0 and about 0.5, and x is an integer of about 15 to about 264.

Suitable ion exchangers based on aluminosilicate are commercially available. These aluminosilicates may be of crystalline or amorphous structure, and may be naturally occurring or else synthetically produced. Processes for the production of ion exchangers based on aluminosilicate are described in U.S. Pat. No. 3,985,669 and U.S. Pat. No. 4,605,509. Preferred ion exchangers based on synthetic crystalline aluminosilicates are obtainable under the name zeolite A, zeolite P(B) (including those disclosed in EP-A-0 384 070) and zeolite X. Preference is given to aluminosilicates with a particle diameter between 0.1 and 10 μm.

Suitable organic builders include polycarboxyl compounds, such as, for example, ether polycarboxylates and oxydisuccinates, as described, for example in U.S. Pat. No. 3,128,287 and U.S. Pat. No. 3,635,830. Reference should likewise be made to “TMS/TDS” builders from U.S. Pat. No. 4,663,071.

Other suitable builders include the ether hydroxypolycarboxylates, copolymers of maleic anhydride with ethylene or vinyl methyl ether, 1,3,5-trihydroxybenzene-2,4,6-trisulfonic acid and carboxymethyloxy-succinic acid, the alkali metal, ammonium and substituted ammonium salts of polyacetic acids, such as, for example, ethylenediaminetetraacetic acid and nitrilotriacetic acid, and also polycarboxylic acids, such as mellitic acid, succinic acid, oxydisuccinic acid, polymaleic acid, benzene-1,3,5-tricarboxylic acid, carboxymethyloxysuccinic acid, and soluble salts thereof.

Builders based on citrates, for example citric acid and its soluble salts, in particular the sodium salt, are preferred polycarboxylic acid builders, which can also be used in granulated formulations, in particular together with zeolites and/or sheet silicates.

Further suitable builders are the 3,3-dicarboxy-4-oxa-1,6-hexanedioate and the related compounds which are disclosed in U.S. Pat. No. 4,566,984.

If builders based on phosphorus can be used, and in particular if soap bars for washing by hand are to be formulated, various alkali metal phosphates, such as, for example, sodium tripolyphosphate, sodium pyrophosphate and sodium orthophosphate, can be used. It is likewise possible to use phosphonate builders, such as ethane-1-hydroxy-1,1-diphosphonate and other known phosphonates, as disclosed, for example in U.S. Pat. No. 3,159,581, U.S. Pat. No. 3,213,030, U.S. Pat. No. 3,422,021, U.S. Pat. No. 3,400,148 and U.S. Pat. No. 3,422,137.

The detergents and cleaner compositions of the present invention can optionally comprise one or more conventional bleaches, and also activators or stabilizers, in particular peroxy acids, which do not react with the polyesters according to the invention.

The peroxy acid can either be a free peroxy acid, or a combination of an inorganic persalt, for example sodium perborate or sodium percarbonate, and an organic peroxy acid precursor, which is converted to a peroxy acid when the combination of the persalt and of the peroxy acid precursor is dissolved in water. The organic peroxy acid precursors are often referred to in the prior art as bleach activators.

Examples of peroxy acids which are preferred for use in this invention include peroxydodecanedioic acid (DPDA), the nonylamide of peroxysuccinic acid (NAPSA), the nonylamide of peroxyadipic acid (NAPAA) and decyldiperoxysuccinic acid (DDPSA). The peroxy acid is preferably present in soluble granules, corresponding to the method from U.S. Pat. No. 4,374,035.

Preferred bleach granules comprise, in percentages by weight, 1% to 50% of an exothermically soluble compound, such as, for example, boric acid; 1% to 25% of a surface-active ingredient compatible with the peroxy acid, such as, for example, C13LAS; 0.1% to 10% of one or more chelate stabilizers, such as, for example, sodium pyrophosphate; and 10% to 70% of a water-soluble salt, such as, for example, sodium sulfate.

The peroxy-acid-containing bleach is used in amounts which produce an amount of available oxygen of between about 0.1% and about 10%, preferably between about 0.5% and about 5%, in particular from about 1% to 4%. The percentages given refer to the total weight of the cleaner composition.

Suitable amounts of the peroxy-acid-containing bleach, based on a unit dose the detergent compositions according to the invention, as is used for a typical wash liquor which comprises about 65 liters of water at 15 to 60° C. produce between about 1 ppm to about 150 ppm of available oxygen, preferably between about 2 ppm to about 20 ppm of available oxygen. The wash liquor should have a pH between 7 and 11, preferably between 7.5 and 10.5, in order to achieve an adequate bleaching result. Reference is made to column 6, lines 1 to 10 of U.S. Pat. No. 4,374,035.

Alternatively to this, the bleach composition can comprise a suitable organic peroxy acid precursor which produces one of the abovementioned peroxy acids when it reacts with hydrogen peroxide in aqueous alkaline solution. The source of the hydrogen peroxide may be any inorganic peroxide which liberates hydrogen peroxide in aqueous solution, such as, for example, sodium perborate (monohydrate and tetrahydrate) and sodium percarbonate.

Bleach activators that are available are N,N,N′,N′-tetraacetylethylenediamine (TAED), glucose pentaacetate (GPA), xylose tetraacetate (TAX), sodium 4-benzoyloxybenzenesulfonate (SBOBS), sodium trimethylhexanoyloxybenzenesulfonate (STHOBS), tetraacetylglucoluril (TAGU), tetraacetylcyanic acid (TACA), di-N-acetyldimethylglyoxine (ADMG) and 1-phenyl-3-acetylhydantoin (PAH), nonanoylcaprolactam phenylsulfonate ester (APES), nonanoylphenyl sulfonate ester (NOPS), nitrilotriacetate (NTA) and ammonium nitriles.

The detergent and cleaner compositions according to the invention can comprise one or more conventional enzymes. Such enzymes are, for example, lipases, amylases, proteases, cellulases, pullinases, cutinases, peroxidases. Proteases that are available are BLAP®, Opticlean®, Maxacal®, Maxapem®, Esperase®, Savinase®, Purafect®, OxP and/or Duraxym®, available amylases are Termamyl®, Amylase-LT®, Maxamyl®, Duramyl®, and/or Pruafect® OxAm, available lipases are Lipolase®, Lipomax®, Lumafast® and/or Lipozym®. A preferred enzyme is cellulase. The cellulase used here can be obtained from bacteria or fungi and should have an optimum pH range between 5 and 9.5. Preferred cellulases are described in WO-91/17 243.

Likewise preferred enzymes are lipases which, being fat-cleaving enzymes, permit better detachment of native oils and fats from soiled fabrics and thus assist the polyesters according to the invention in their effect, where generally additive, and also synergistic, effects can be achieved.

The enzymes can be adsorbed to carrier substances and/or embedded in coating substances.

Based on the weight of the detergent and cleaner compositions which comprise the polyesters according to the invention, the fraction of enzymes is at least 0.001% by weight, preferably between about 0.001 to about 5% by weight, in particular from about 0.001 to about 1% by weight, specifically from about 0.01 to about 1% by weight.

Sequestrants that are available are sodium tripolyphosphate (STPP), ethylenediaminetetraacetic acid (EDTA), salts, nitrilotriacetic acid (NTA), polyacrylate, phosphonate, oxalic acid, oxalic acid salt, citric acid, zeolite, condensed phosphates, carbonates, polycarbonates.

Suitable graying inhibitors are carboxymethylcellulose, methylcellulose, hydroxyalkylcellulose, methylhydroxyethylcellulose, methylhydroxypropylcellulose, methylcarboxymethylcellulose and polyvinylpyrrolidone.

Color transfer inhibitors are also suitable, for example polyamine N-oxides, such as, for example, poly(4-vinylpyridine N-oxide), e.g. Chromabond S400, ISP; polyvinylpyrrolidone, e.g. Sokalan® HP 50/BASF and copolymers of N-vinylpyrrolidone with N-vinylimidazole and optionally other monomers.

The invention includes detergents and cleaners comprising color fixatives as active substances, for example color fixatives which are obtained by reacting diethylenetriamine, dicyandiamide and amidosulfuric acid, amines with epichlorohydrin, for example dimethylaminopropylamine and epichlorohydrin or dimethylamine and epichlorohydrin or dicyandiamide, formaldehyde and ammonium chloride, or dicyandiamide, ethylenediamine and formaldehyde or cyanamide with amines and formaldehyde or polyamines with cyanamides and amidosulfuric acid or cyanamides with aldehydes and ammonium salts, but also polyamine N-oxides, such as, for example, poly(4-vinylpyridine N-oxide), e.g. Chromabond S400, ISP; polyvinylpyrrolidone, e.g. Sokalan® HP 50/BASF and copolymers of N-vinylpyrrolidone with N-vinylimidazole and optionally other monomers.

The detergents and cleaners according to the invention can comprise complexing agents, for example aminocarboxylates, such as ethylenediamine tetraacetate, N-hydroxyethylethylenediamine triacetate, nitrilotriacetate, ethylenediamine tetrapropionate, triethylenetetraamine hexaacetate, diethylenetriamine pentaacetate, cyclohexanediamine tetraacetate, phosphonates, for example azacycloheptanediphosphonate, Na salt, pyrophosphates, etidronic acid (1-hydroxyethylidene-1,1-diphosphonic acid, 1-hydroxyethyane-1,1-diphosphonic acid, acetophosphonic acid) and its salts, aminophosphonates, such as ethylenediamine tetrakis(methylenephosphonate), diethylenetriamine pentakis(methylenephosphonate), amine trimethylenephosphonic acid, cyclodextrines, and polyfunctionally substituted aromatic complexing agents, such as dihydroxydisulfobenzene or ethylenediamine disuccinates.

Optical brighteners which can be used are cyclic hydrocarbons, such as distyrylbenzenes, distyrylbiphenyls, diphenylstilbenes, triazinylamino-stilbenes, stilbenzyl-2H-triazoles, for example stilbenzyl-2H-napthol[1,2-d]triazoles and bis(1,2,3-triazol-2-yl)stilbenes, benzoxazoles, for example stilbenzylbenzoxazole and bis(benzoxazole), furans, benzofurans and benzimidazoles, for example bis(benzo[b]furan-2-yl)biphenyl and cationic benzimidazoles, 1,3-diphenyl-2-pyrazoline, coumarin, naphthalimides, 1,3,5-2-yl derivatives, methine cyanine and dibenzothiophene 5,5-oxide.

Preference is given to anionic optical brighteners, in particular sulfonated compounds.

Also of suitability are triazinylaminostilbenes, distyrylbiphenyls and mixtures thereof, 2-(4-styrylphenyl)-2H-naphtho[1,2-d]triazole, 4,4′-bis(1,2,3-triazol-2-yl)stilbene, aminocoumarin, 4-methyl-7-ethylaminocoumarin, 1,2-bis(benzimidazol-2-yl)ethylene, 1,3-diphenylphrazoline, 2,5-bis(benzo-oxazol-2-yl)thiophene, 2-strylnaphtho[1,2-d]oxazole, 2-(4-styryl-3-sulfophenyl)-2H-naphthol[1,2-d]triazole and 2-(stilben-4-yl)-2H-naphthol[1,2-d]triazole.

The detergents according to the invention can comprise optical brighteners in amounts of from 0.001% by weight to 2% by weight, preferably 0.002% by weight to 0.8% by weight, particularly preferably 0.003% by weight to 0.4% by weight.

The softening components used are quaternary ammonium salts of the type

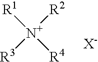

in which
R¹=C₈-C₂₄ n- or isoalkyl, preferably C₁₀-C₁₈ n-alkyl
R²=C₁-C₄-alkyl, preferably methyl

### R³=R¹ or R²

R⁴=R² or hydroxyethyl or hydroxypropyl or oligomers thereof
X⁻=bromide, chloride, iodide, methosulfate, acetate, propionate, lactate.

Examples thereof are distearyldimethylammonium chloride, ditallowalkyldimethylammonium chloride, ditallowalkylmethylhydroxy-propylammonium chloride, cetyltrimethylammonium chloride or else the corresponding benzyl derivatives, such as, for example, dodecyldimethylbenzylammonium chloride. Cyclic quaternary ammonium salts, such as, for example, alkylmorpholine derivatives, can likewise be used.

Moreover, besides the quaternary ammonium compounds, imidazolinium compounds (1) and imidazoline derivatives (2) can be used.

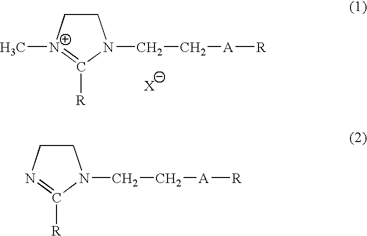

in which
R=C₈-C₂₄ n- or isoalkyl, preferably C₁₀-C₁₈ n-alkyl
X=bromide, chloride, iodide, methosulfate

### A=—NH—CO—, —CO—NH—, —O—CO—, —CO—O—.

A particularly preferred compound class is the so-called ester quats. These are reaction products of alkanolamines and fatty acids, which are then quaternized with customary alkylating or hydroxyalkylating agents.

Preferred alkanolamines are compounds according to the formula

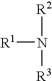

where
R¹=C₁-C₃ hydroxyalkyl, preferably hydroxyethyl and
R², R³=R¹ or C₁-C₃ alkyl, preferably methyl.

Particular preference is given to triethanolamine and methyldiethanolamine.

Further particularly preferred starting materials for ester quats are aminoglycerol derivatives, such as, for example, dimethylaminopropanediol. Alkylation and hydroxyalkylation agents are alkyl halides, preferably methyl chloride, dimethyl sulfate, ethylene oxide and propylene oxide.

Examples of ester quats are compounds of the formulae:

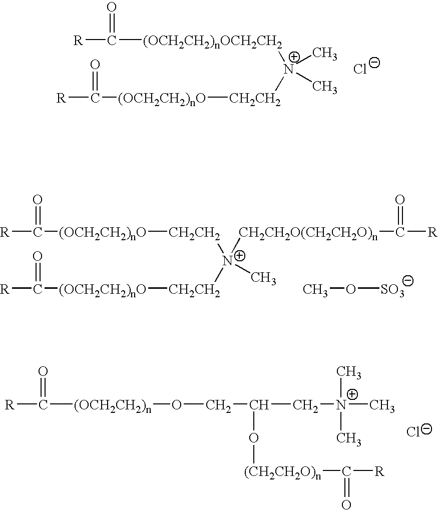

where R—C—O is derived from C₈-C₂₄-fatty acids which may be saturated or unsaturated. Examples thereof are caproic acid, caprylic acid, hydrogenated or unhydrogenated or only partially hydrogenated tallow fatty acids, stearic acid, oleic acid, linolenic acid, behenic acid, palmitostearic acid, myristic acid and elaidic acid. n is in the range from 0 to 10, preferably 0 to 3, particularly preferably 0 to 1.

Further preferred fabric softener raw materials with which the polyesters according to the invention can be combined are amidoamines based on, for example, dialkyltriamines and long-chain fatty acids, and their oxethylates or quaternized variants. These compounds have the following structure:

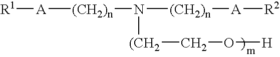

in which
R¹ and R² independently of one another are C₈-C₂₄ n- or isoalkyl, preferably C₁₀-C₁₈ n-alkyl,

### A is —CO—NH— or —NH—CO—,

n is 1-3, preferably 2,
m is 1-5, preferably 2-4.

By quaternizing the tertiary amino group, it is additionally possible to introduce the radical R³, which may be C₁-C₄-alkyl, preferably methyl, and a counterion X, which may be chloride, bromide, iodide or methyl sulfate. Amidoaminooxethylates and their quaternized secondary products are supplied under the trade names ®Varisoft 510, ®Varisoft 512, ®Rewopal V 3340 and ®Rewoquat W 222 LM.

The preferred use concentrations of the polyesters used according to the invention in the softener formulations correspond to those specified for detergent formulations.

The detergents and cleaners according to the invention preferably comprise dyes and fragrances or perfumes.

As dyes, preference is given to Acid Red 18 (Cl 116255), Acid Red 26, Acid Red 27, Acid Red 33, Acid Red 51, Acid Red 87, Acid Red 88, Acid Red 92, Acid Red 95, Acid Red 249 (Cl)18134, Acid Red 52 (Cl45100), Acid Violet 126, Acid Violet 48, Acid Violet 54, Acid Yellow 1, Acid Yellow 3 (Cl47005), Acid Yellow 11, Acid Yellow 23 (Cl 19140), Acid Yellow 3, Direct Blue 199 (Cl74190), Direct Yellow 28 (Cl19555), Food Blue 2 (Cl42090), Food Blue 5:2 (Cl 42051:2), Food Red 7 (Cl 16255), Food Yellow 13 (Cl 47005), Food Yellow 3 (Cl 15985), Food Yellow 4 (Cl 19140), Reactive Green 12, Solvent Green 7 (Cl 59040).

Particularly preferred dyes are water-soluble acid dyes, for example Food Yellow 13 (Acid Yellow 3, Cl 47005), Food Yellow 4 (Acid Yellow 23, Cl 19140), Food Red 7 (Acid Red 18, Cl 16255), Food Blue 2 (Acid Blue 9, Cl 42090), Food Blue 5 (Acid Blue 3, Cl 42051), Acid Red 249 (Cl 18134), Acid Red 52 (Cl 45100), Acid Violet 126, Acid Violet 48, Acid Blue 80 (Cl 61585), Acid Blue 182, Acid Blue 182, Acid Green 25 (Cl 61570), Acid Green 81.

Water-soluble direct dyes, for example Direct Yellow 28 (Cl 19555), Direct Blue 199 (Cl 74190) and water-soluble reactive dyes, for example Reactive Green 12, and also the dyes Food Yellow 3 (Cl 15985), Acid Yellow 184, are also likewise preferably used.

Aqueous dispersions of the following pigment dyes are likewise preferably used, the concentration of the dye dispersions used for coloring solutions or dispersions being in the range from 0.1% by weight to 50% by weight, preferably 1% by weight to 45% by weight, particularly preferably 5% by weight to 40% by weight and extraordinarily preferably between 10% by weight and 35% by weight. It is known to the person skilled in the art that the aqueous pigment dispersions comprise dispersants and optionally further auxiliaries, for example biocides, besides the pigments.

Suitable pigment dyes are Pigment Black 7 (Cl 77266), Pigment Blue 15 (Cl 74160), Pigment Blue 15:1 (Cl 74160), Pigment Blue 15:3 (Cl 74160), Pigment Green 7 (Cl 74260), Pigment Orange 5, Pigment Red 112 (Cl 12370), Pigment Red 112 (Cl 12370), Pigment Red 122 (Cl 73915), Pigment Red 179 (Cl 71130), Pigment Red 184 (Cl 12487), Pigment Red 188 (Cl 12467), Pigment Red 4 (Cl 12085), Pigment Red 5 (Cl 12490), Pigment Red 9, Pigment Violet 23 (Cl 51319), Pigment Yellow 1 (Cl 11680), Pigment Yellow 13 (Cl 21100), Pigment Yellow 154, Pigment Yellow 3 (Cl 11710), Pigment Yellow 74, Pigment Yellow 83 (Cl 21108), Pigment Yellow 97.

In preferred embodiments, the following pigment dyes are used in the form of dispersions: Pigment Yellow 1 (Cl 11680), Pigment Yellow 3 (Cl 11710), Pigment Red 112 (Cl 12370), Pigment Red 5 (Cl 12490), Pigment Red 181 (Cl 73360), Pigment Violet 23 (Cl 51319), Pigment Blue 15:1 (Cl 74160), Pigment Green 7 (Cl 74260), Pigment Black 7 (Cl 77266).

In likewise preferred embodiments, water-soluble polymer dyes, for example Liquitint RTM, Liquitint Blue HP.RTM., Liquitint Blue 65.RTM., Liquitint Patent Blue.RTM., Liquitint Royal Blue.RTM., Liquitint Experimental Yellow 8949-43.RTM., Liquitint Green HMC.RTM., Liquitint Yellow II.RTM., and mixtures thereof are used.

Fragrances and perfumes that can be used are individual odorant compounds, e.g. the synthetic products of the ester type, ether type, aldehyde type, ketone type, alcohol type and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethylacetate, linalyl benzoate, benzyl formate, ethyl methylphenylglycinate, allyl cyclohexylpropionate, styrallyl propionate and benzyl salicylate. The ethers include, for example, benzyl ethyl ether, the aldehydes include, for example, the linear alkanals having 8 to 18 carbon atoms, citral, citronellal, citronellyloxyacetaldehyde, hydroxycitronellal, lilial and bourgeonal, the ketones include, for example, the ionones, alpha-isomethylionone and methyl cedryl ketone, the alcohols include anethole, citronellol, eugenol, geranion, linalool, phenylethyl alcohol and terpineol, the hydrocarbons include primarily the terpenes and balsams. Preference is given to using mixtures of different odorants which together produce a pleasant scent note.

Perfume oils can also comprise natural odorant mixtures, as are accessible from plant or animal sources, e.g. pine oil, citrus oil, jasmine oil, lily oil, rose oil or ylang-ylang oil. Essential oils of relatively low volatility, which are mostly used as aroma components, are also suitable as perfume oils, e.g. sage oil, chamomile oil, oil of cloves, Melissa oil, mint oil, cinnamon leaf oil, linden blossom oil and juniper berry oil.

Preference is given to using solutions or emulsions of the abovementioned fragrances and perfume oils which can be prepared by customary methods.

The examples below serve to illustrate the subject matter of the invention in more detail without limiting it thereto.

### EXAMPLE 1

### Polyester 1

281.5 g of 1,2-propanediol, 229.6 g of ethylene glycol, 250 g of PEG-250 monomethyl ether, 970.9 g of dimethyl terephthalate and 236.98 g of dimethyl 5-sulfoisophthalate Na salt were initially introduced into a 2 l four-necked flask fitted with precision-ground glass stirrer, internal thermometer, gas inlet tube and distillation bridge, and the reaction mixture is then rendered inert by introducing N₂. In countercurrent, 1 g of titanium tetraisopropoxide and 0.8 g of sodium acetate were then added to the reaction mixture. The mixture was slowly heated on an oil bath, during which from an internal temperature of about 120-150° C., the solid components started to melt. With stirring, the mixture was then heated to 190° C. over the course of 30 min. At about 173° C., the transesterification and distillation started. In the course of 2 hours, the internal temperature was increased to 210° C. until the amount of condensate required according to the stoichiometry was reached. The oil bath temperature was then increased to about 240-250° C. and the internal pressure was reduced to best oil pump vacuum over the course of 30 minutes. During the three-hour vacuum phase, the condensation was completed by distilling off the excess amount of alcohol. During this time, the internal temperature of the polyester melt slowly increased to about 220° C. at the end of the reaction. Aeration with N₂ was then carried out and the melt was discharged onto metal sheets.

### EXAMPLE 2

### Polyester 2

418.5 g of 1,2-propanediol, 279.3 g of ethylene glycol, 212.4 g of tetraethylene glycol monomethyl ether, 1359.3 g of dimethyl terephthalate and 296.22 g of dimethyl 5-sulfoisophthalate Na salt and 250 g of polyethylene glycol 250 were initially introduced into a 3 l four-necked flask fitted with precision-ground glass stirrer, internal thermometer, gas inlet tube and distillation bridge, and the reaction mixture was then rendered inert by introducing N₂. In countercurrent, 1.5 g of sodium methoxide and 0.5 g of sodium carbonate were then added to the reaction mixture. The mixture was slowly heated on an oil bath, during which from an internal temperature of about 120-150° C., the solid components started to melt. With stirring, the mixture was then heated to 190° C. over the course of 30 min. At about 173° C., the transesterification and distillation started. In the course of 2 hours, the internal temperature was increased to 210° C. until the amount of condensate required according to the stoichiometry was reached. The oil bath temperature was then increased to about 240-250° C. and the internal pressure was reduced to best oil pump vacuum over the course of 30 minutes. During the three-hour vacuum phase, the condensation was completed by distilling off the excess amount of alcohol. During this time, the internal temperature of the polyester melt increased slowly to about 220° C. at the end of the reaction. Aeration with N₂ was then carried out and the melt was discharged onto metal sheets.

### EXAMPLE 3

### Polyester 3

281.5 g of 1,2-propanediol, 223.4 g of ethylene glycol, 202 g of triethylene glycol monomethyl ether, 582.5 g of dimethyl terephthalate and 296.22 g of dimethyl 5-sulfoisophthalate Na salt were initially introduced into a 3 l four-necked flask fitted with precision-ground glass stirrer, internal thermometer, gas inlet tube and distillation bridge, and the reaction mixture was then rendered inert by introducing N₂. In countercurrent, 1.02 g of titanium tetraisopropoxide and 0.8 g of sodium acetate were then added to the reaction mixture. The mixture was slowly heated on an oil bath, during which from an internal temperature of about 120-150° C., the solid components started to melt. With stirring, the mixture is now heated to 195° C. over the course of 45 min. At about 173° C., the transesterification and distillation started. Over the course of 3 hours, the internal temperature was increased to 210° C. until the amount of condensate required according to the stoichiometry was reached. The oil bath temperature was then increased to about 240-255° C. and the internal pressure was reduced to <20 mbar over the course of 60 minutes. During the four-hour vacuum phase, the condensation was completed by distilling off the excess amount of alcohol. During this time, the internal temperature of the polyester melt slowly increased to 225° C. at the end of the reaction. Aeration with N₂ was then carried out and the melt was discharged onto metal sheets.

### EXAMPLE 4

### Polyester 4

### Reaction Procedure According to Example 2

### Components:

281.5 g 1,2-propanediol
223.4 g ethylene glycol
776.7 g dimethyl terephthalate
355.5 g dimethyl 5-sulfoisophthalate Na salt
295.5 g tallow fatty alcohol with 8 units of ethylene oxide (Genapol T080)
1.00 g titanium tetraisopropoxide
0.8 g sodium acetate

### EXAMPLE 5

### Polyester 5

### Reaction Procedure According to Example 3

### Components:

620.6 g ethylene glycol
970.9 g dimethyl terephthalate
444.3 g dimethyl 5-sulfoisophthalate Na salt
162 g triethylene glycol monobutyl ether
1.00 g titanium tetraisopropoxide
0.8 g sodium acetate

### EXAMPLE 6

### Polyester 6

### Reaction Procedure According to Example 1

### Components:

152.2 g 1,2-propanediol
124.1 g ethylene glycol
388.3 g dimethyl terephthalate
177.7 g 5-sulfoisophthalic acid Li salt
100 g lauryl alcohol with 7 units of ethylene oxide (Genapol LA 070)
1.00 g titanium tetraisopropoxide

### EXAMPLE 7

### Polyester 7

### Reaction Procedure According to Example 1

### Components:

422.3 g 1,2-propanediol
335.1 g ethylene glycol
873.8 g dimethyl terephthalate
177.7 g 5-sulfoisophthalic acid Na salt
100 g triethylene glycol monomethyl ether
50 g polyethylene glycol 500
50 g polyethylene glycol 1500
1.00 g titanium tetraisopropoxide

### EXAMPLE 8

### Polyester 8

### Reaction Procedure According to Example 1

### Components:

380.5 g 1,2-propanediol
186.2 g ethylene glycol
873.8 g dimethyl terephthalate
444.3 g 5-sulfoisophthalic acid Na salt
125 g tripropylene glycol monomethyl ether
150 g ethylene oxide-propylene oxide copolymer (Genapol PF 20)
1.00 g titanium tetraisopropoxide

### EXAMPLE 9

### Polyester, Partially Terminally Capped with Sulfone Groups

Reaction procedure and components analogous to example 3, replacing 50 mol % of triethylene glycol monomethyl ether for the sodium salt of isethionic acid.

The polyesters according to the invention were compared with soil release polymers of the prior art with regard to their hygroscopicity and with regard to their soil release effect.

### Soil Release Test:

The anionic soil release polyesters according to the invention were tested with regard to their soil release effect using the “dirty motor oil test”.

For this, the polymers were added to the particular wash liquors in a concentration of 1% (active ingredient), based on the test detergents used. White polyester fabric Testex PES 730 (Testfabrics Inc., USA) was prewashed using these wash liquors. The fabrics pretreated in this way were dried and then soiled with dirty motor oil. After a contact time of one hour, the soiled fabric test pieces were washed again under the same washing conditions using the respective test detergents with the addition of the polymers according to the invention. The reflectance of the test fabrics was then measured.

For comparison, the dirty motor oil test was carried out with the test detergents without soil release polymers and also with the addition of commercial soil release polymers, which represent the prior art.

The test detergents used for the dirty motor oil test were the standard washing powders IEC-A and IEC-B from Wäschereiforschung Krefeld, a color washing powder and a liquid detergent (Tables 1 to 4):

TABLE 1
IEC-A washing powder (phosphate-free, with bleach)

| | |
|---|---|
| Alkylbenzenesulfonate, Na salt | 8.8% |
| C12-18-alcohol ethoxylate with 7 EO | 4.7% |
| Soap | 3.2% |
| Foam inhibitor DC2-4248S, Dow Corning | 3.9% |
| Zeolite 4A | 28.3% |
| Soda | 11.6% |
| Polycarboxylate (Sokalan ® CP5) | 2.4% |
| Sodium silicate | 3.0% |
| Carboxymethylcellulose | 1.2% |
| Phosphonate (Dequest 2066) | 2.8% |
| Optical brightener | 0.2% |
| Sodium sulfate | 6.5% |
| Protease Savinase 8.0, Novo Nordisk | 0.4% |
| TAED | 5.0% |
| Sodium percarbonate | 18.0% |

TABLE 2
IEC-B washing powder (phosphate-containing, without bleach)

| | |
|---|---|
| Alkylbenzenesulfonate, Na salt | 8.0% |
| C12-18-alcohol ethoxylates with 14 EO | 2.9% |
| Soap | 3.5% |
| Sodium tripolyphosphate | 43.8% |
| Sodium silicate | 7.5% |
| Magnesium silicate | 1.9% |
| Carboxymethylcellulose | 1.2% |
| EDTA | 0.2% |
| Optical brightener | 0.2% |
| Sodium sulfate | 21.0% |
| Water | 9.8% |

TABLE 3
Color washing powder (phosphate-free, without bleach)

| | |
|---|---|
| Alkylbenzenesulfonate, Na salt | 11.5% |
| C12-18-alcohol ethoxylate with 7 EO | 6.0% |
| Soap | 4.5% |
| Foam inhibitor DC2-4248S, Dow Corning | 5.0% |
| Zeolite 4A | 37.0% |
| Soda | 15.0% |
| Polycarboxylate (Sokalan ® CP5) | 3.0% |
| Sodium silicate | 4.0% |
| Carboxymethylcellulose | 1.6% |
| Phosphonate (Dequest 2066) | 2.0% |
| Protease | 0.5% |
| Polyvinylpyrrolidone | 0.5% |
| Sodium sulfate | 9.4% |

TABLE 4
Liquid detergent

| | |
|---|---|
| Genapol OA-080 | 12.0% |
| Coconut fatty acid | 14.0% |
| Potassium hydroxide (85% strength) | 2.6% |
| Triethanolamine | 2.0% |
| 1,2-Propylene glycol | 5.0% |
| Water | 42.4% |
| Trisodium citrate 2-hydrate | 5.0% |
| Linear alkylbenzenesulfonate, Na salt | 10.0% |
| Hydroxyethanediphosphonic acid (HEDP) | 4.0% |
| Ethanol | 3.0% |

The dirty motor oil test was carried out according to the washing conditions stated in Table 5:

TABLE 5
Washing conditions

| Washing machine: | Linitest |
|---|---|
| Water hardness: | 15°dH |
| Liquor ratio: | 1:40 |
| Washing temperature: | 40° C. |
| Washing time: | 30 min |
| Detergent concentration: | 6 g/l |

The following commercial soil release polymers were also tested for comparison (Table 6).

TABLE 6
Commercial soil release polymers as comparative examples

| | |
|---|---|
| Comparative example 1: | ® Repel-O-Tex SRP 4 (Rhodia): |
| Comparative example 2: | ® Repel-O-Tex SRP 6 (Rhodia): |
| Comparative example 3: | ® Marloquest SL (Sasol): |
| Comparative example 4: | ® Sokalan SR 100 (BASF). |

The following test results were obtained with the soil release test (Tables 7 to 9).

TABLE 7
Soil release effect of the soil release polyesters according to
the invention compared to soil release polyesters of the prior
art in the washing powder IEC-A according to Table 1.

| | Reflectance (%) |
|---|---|
| IEC-A without additive | 15.6 |
| +1% soil release polymer: | |
| Comparative example 1 | 16.2 |
| Comparative example 2 | 18.7 |
| Comparative example 3 | 15.5 |
| Comparative example 4 | 14.8 |
| Polyester according to example 3 | 62.7 |

TABLE 8
Soil release effect of the soil release polyesters according to
the invention compared to soil release polyesters of the prior
art in the washing powder IEC-B according to Table 2.

| | Reflectance (%) |
|---|---|
| IEC-B without additive | 15.6 |
| +1% soil release polymer: | |
| Comparative example 1 | 15.2 |
| Comparative example 2 | 15.5 |
| Comparative example 3 | 15.3 |
| Comparative example 4 | 15.4 |
| Polyester according to example 3 | 65.3 |

TABLE 9
Soil release effect of the soil release polyesters according to
the invention compared to soil release polyesters of the prior
art in the color washing powder according to Table 3.

| | Reflectance (%) |
|---|---|
| Color washing powder without | 16.1 |
| additive | |
| +1% soil release polymer: | |
| Comparative example 2 | 17.2 |
| Comparative example 3 | 16.3 |
| Polyester according to example 3 | 35.8 |

Table 10: Soil release effect of the soil release polyesters according to the invention compared to soil release polyesters of the prior art in the liquid detergent according to table 4.

### Primary Detergency:

The soil release polymers according to the invention were further investigated with regard to their primary detergency using a multiple washing of test soil fabrics.

For this, polyester test soil fabric wfk 20C and wfk 30C (Wäschereiforschungsanstalt Krefeld) was washed four times with the test detergents according to Table 1 and Table 2 and an additive of in each case 1% (WS) of the polymers. After each wash, the reflectance values (degrees of whiteness) were determined.

The washing conditions correspond to those in Table 5. Soil release polymers of the prior art served as comparison. The following results were obtained (Tables 11 to 13).

TABLE 10
Primary detergency in IEC-A on polyester/cotton WFK 20 C.

Reflectance (%) depending
on the wash cycles

| Detergent formulation | 1 x | 2 x | 3 x | 4 x |
|---|---|---|---|---|
| IEC-A without additive | 44.6 | 47.6 | 48.9 | 50.5 |
| +1% soil release polymer: | | | | |
| Comparative example 2 | 45.0 | 49.7 | 52.5 | 54.8 |
| Comparative example 4 | 44.7 | 47.2 | 49.1 | 50.3 |
| Polyester according to | 46.1 | 53.9 | 59.7 | 64.9 |
| example 3 | | | | |

TABLE 11
Primary detergency in IEC-A on polyester WFK 30 C.

| | 1 x | 2 x | 3 x | 4 x |
|---|---|---|---|---|
| IEC-A without additive | 39.6 | 42.4 | 43.8 | 44.8 |
| +1% soil release polymer: | | | | |
| Comparative example 2 | 40.0 | 43.3 | 45.1 | 46.4 |
| Comparative example 4 | 41.0 | 44.1 | 45.8 | 46.9 |
| Polyester according to | 42.6 | 51.0 | 57.5 | 61.3 |
| example 3 | | | | |

TABLE 12
Primary detergency in IEC-B on polyester/cotton WFK 20 C

| | 1 x | 2 x | 3 x | 4 x |
|---|---|---|---|---|
| IEC-B without additive | 44.1 | 47.6 | 49.0 | 50.3 |
| +1% soil release polymer: | | | | |
| Comparative example 2 | 46.3 | 50.5 | 52.8 | 54.7 |
| Comparative example 4 | 45.3 | 49.2 | 50.5 | 52.7 |
| Polyester according to | 46.4 | 58.3 | 66.6 | 73.4 |
| example 3 | | | | |

TABLE 13
Primary detergency in IEC-B on polyester WFK 30 C

| | 1 x | 2 x | 3 x | 4 x |
|---|---|---|---|---|
| IEC-B without additive | 44.0 | 46.5 | 47.9 | 48.8 |
| +1% soil release polymer: | | | | |
| Comparative example 2 | 45.0 | 47.6 | 49.3 | 49.9 |
| Comparative example 4 | 44.6 | 47.3 | 48.8 | 49.5 |
| Polyester according to | 44.6 | 52.8 | 58.7 | 61.4 |
| example 3 | | | | |

The polyesters according to the invention were compared with soil release polymers of the prior art with regard to their hygroscopicity.

TABLE 14
Hygroscopicity of a copolymer according to the invention
compared to other anionic soil release polymers
Open storage at 25° C. and 65% atmospheric humidity; the
parameter measured was the absorption of water g of H₂O/per
kg of SRP

| SRP | 30 min | 60 min | 90 min | 120 min |
|---|---|---|---|---|
| Polyester 13 | 1 | 4 | 5 | 5 |
| Polyester 9 | 20 | 30 | 40 | 55 |
| SRA 200 | 30 | 60 | 78 | 92 |

The result shows that the polyester according to the invention (polyester 3) has significantly lower hygroscopicity than analogous polyesters with sulfone-containing end groups (polyester 9 and SRA 200).

### Chemical Name of the Commercial Products Used

| | |
|---|---|
| Repel-O-Tex SRP 4, Rhodia, | ethylene glycol-polyethylene glycol- |
| | terephthalic acid copolymer, |
| | remainder sodium sulfate and sodium |
| | aluminum silicate |
| Repel-O-Tex SRP 6, Rhodia, | ethylene glycol-polyethylene glycol- |
| | terephthalic acid copolymer, |
| | remainder sodium sulfate and sodium |
| | aluminum silicate |
| Marloquest SL, Sasol | 25% nonionic polycondensate on |
| Sokalan SR 100, BASF | 75% zeolite A |
| SRA 200 Clariant | ethylene glycol-polyethylene glycol- |
| | terephthalic acid-isethionic acid Na |
| | salt copolymer |
| Foam inhibitor DC2-4248S | Dow Corning, polysiloxane |

1. A polyester consisting of structural units 1 to 3 or 1 to 4 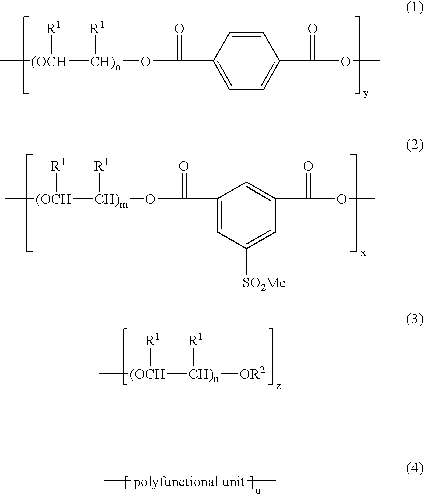
where
R¹, independently of the others, is H, a (C₁-C₁₈) n- or an isoalkyl group,
R² is a linear or branched (C₁-C₃₀)-alkyl group, a linear or branched (C₂-C₃₀)-alkenyl group, a cycloalkyl group having 5 to 9 carbon atoms, a (C₆-C₃₀) aryl group or a (C₆-C₅₀) arylalkyl group,
m and o, independently of one another, are a number from 1 to 200,
n is a number from 1 to 5,
x, y and z, independently of one another, are numbers from 1 to 50,
with the proviso that x+y must be ≧2 and z must be >0,
u is a number from 0 to 5, and
Me is Li⁺, Na⁺, K⁺, Mg⁺⁺/2, Ca⁺⁺/2, Al⁺⁺⁺/3, NH₄⁺, a monoalkylammonium ion, dialkylammonium ion, trialkylammonium ion tetraalkylammonium ion or a combination thereof, where the alkyl substituents of the ammonium ions are, independently of one another, (C₁-C₂₂)-alkyl radicals or (C₂-C₁₀)-hydroxyalkyl radicals.

2. The polyester as claimed in claim 1, where R¹ is H, methyl or a combination thereof, R² is methyl, o and m are numbers from 1 to 200, n is a number from 1 to 5, x is a number from 1 to 30, y is a number from 1 to 25 and z is a number from 0.05 to 15.

3. The polyester as claimed in claim 1, where o and m are numbers from 1 to 20 and n is a number from 1 to 5.

4. The polyester as claimed in claim 1, where o, m and n are a number from 1 to 5.

5. The polyester as claimed in claim 1, where o and m are 1 and n is a number from 2 to 10.

6. The polyester as claimed in claim 1, where x is a number from 2 to 15.

7. The polyester as claimed in claim 1, where x is a number from 3 to 10.

8. The polyester as claimed in claim 1, where y is a number from 1 to 10.

9. The polyester as claimed in claim 1, where y is a number from 1 to 5.

10. The polyester as claimed in claim 1, where z is a number from 0.1 to 10.

11. The polyester as claimed in claim 1, where z is a number from 0.25 to 3.

12. The polyester as claimed in claim 1, where u is the number 0.

13. The polyester as claimed in claim 1, having a softening point above 40° C.

14. The polyester as claimed in claim 1, having a softening point between 50 and 200° C.

15. The polyester as claimed in claim 1, having a softening point between 80 and 150° C.

16. The polyester as claimed in claim 1, having a softening point between 100 and 120° C.

17. A detergent or cleaner comprising a polyester as claimed in claim 1.

18. The polyester as claimed in claim 1, wherein R¹ is methyl.

19. The polyester as claimed in claim 1, wherein u is 0 to 0.5.

20. The polyester as claimed in claim 1, wherein u is 0 to 0.25.
